(19) United States
(12) Patent Application Publication
(10) Pub. No.: US 2019/0350142 A1
(43) Pub. Date: Nov. 21, 2019

(54) SYSTEM AND METHOD FOR PLANT GROWTH CONTROL AND MONITORING

(71) Applicant: Squareroot Corporation, Pontiac, MI (US)

(72) Inventors: John J. Wolak, Pontiac, MI (US); Marie Lee Werve, Los Angeles, CA (US)

(21) Appl. No.: 16/410,141

(22) Filed: May 13, 2019

Related U.S. Application Data
(60) Provisional application No. 62/671,973, filed on May 15, 2018.

(51) Int. Cl. A01G 9/24; A01G 7/04

(52) U.S. Cl. CPC A01G 9/249; A01G 25/167; A01G 7/04

(57) ABSTRACT

Efficient automated plant growth control and monitoring systems with an adjustable light source and a table for rotating a plant. Low voltage power with a community control system configured for growth of plants in low light conditions, such as indoors, underground, or during winter.

### CROSS-REFERENCE TO RELATED APPLICATIONS

This application claims priority to and the benefit of U.S. Provisional Application No. 62/671,973 filed on May 15, 2018, which are incorporated by reference in its entirety herein. Any and all applications for which a foreign or domestic priority claim is identified in the Application Data Sheet as filed with the present application are hereby incorporated by reference under 37 CFR 1.57.

### BACKGROUND

### Field of the Invention

Several embodiments of the invention relate to efficient automated plant growth, gardening, and agricultural control and monitoring systems.

### Description of the Related Art

Agricultural automation improves conditions for growing plants. Conventional automated garden monitoring and plant growth systems tend to use a light source directly above the plants and can employ sensors and programmable timers for the control of irrigation or lighting, and other plant treatment devices that are connected to a server through wireless communications for remote control using a smart phone or computing device. For example, a plant sensor sends a measurement through a wireless router to the server. Plant growing users can access sensor information from the server through Internet enabled devices. Plant growing users can also assign programmable timer schedules, assign a sensor and/or programmable timer to a plant, manually turn on the programmable timer, or let the programmable timer activate whenever a predetermined level is reached. A computer receives data from the sensors and sends commands to the programmable timers using a local wireless data connection.

### SUMMARY

In various embodiments, a plant growth system is a community driven, modular, at-home grow system that learns, creating an optimal environment for plant growth through the use of community-based data analytics and feedback. Provided herein are embodiments of automated systems and methods for plant growth in residential or industrial gardens, green houses, horticultural farms, agricultural farms, and the like. For example, common conventional irrigation systems run on static timers and often waste water when activated during a rain storm or other precipitation. Generally, conventional systems do not adjust operation based on the measured conditions of the plant condition, light, soil or other factors that affect the growth and health of plant life. Gardening and agricultural automation can provide conditions for growing plants in challenging environments. In various embodiments, plant growth systems of the present invention optimize and efficiently improve plant growth in low light conditions, such as in winter, underground, indoors, and other challenging plant growth conditions.

In one embodiment, a plant growth system is a fully immersive, swarm-based environmental control and monitoring plant growth system with an online collective-intellect community. In one embodiment, a plant growth system communicates with low frequency (e.g., 433 Hz) transmissions, which have a much greater range than Wi-Fi. In one embodiment, a plant growth system communicates with a swarm-based communication that allows for a large number of units in a group.

In one embodiment, a data aggregator collects CMS data aggregation with a data analyzer, optionally including a portal for tracking grow cycles and troubleshooting data, with a collect, verify, analyze, archive node data, and runs a user site portal. In one embodiment, a data sharing community CMS (including Grow cycles and/or troubleshooting data) works with a collect, verify, analyze, archive node data and utilizes a user site portal.

In one embodiment, a plant growth system includes a lamp node; a plant monitor node; a table node, a humidifier node; and a power source.

In one embodiment, a plant growth system includes a lamp node comprising a light source and a lens; a plant monitor node; a table node, a humidifier node; and a power source configured to operate the system at 12 to 24 volts. In one embodiment, a plant growth system includes a lamp node comprising a LED array light source and a lens; a plant monitor node; a table node, a humidifier node; and a power source configured to operate the system at 12 to 24 volts. In one embodiment, a plant growth system includes a lamp node comprising a LED array light source and a lens; a plant monitor node; a table node comprising a rotating platform configured for placement of a plant, a humidifier node; and a power source configured to operate the system at 12 to 24 volts. In one embodiment, a plant growth system includes a lamp node comprising a LED array light source and a lens, wherein the LED is configured to produce light in at least one of the blue spectrum, red spectrum, and complete visible spectrum; a plant monitor node; a table node comprising a rotating platform configured for placement of a plant, a humidifier node; and a power source configured to operate the system at 12 to 24 volts.

In various embodiments, a plant growth system includes a lamp node comprising a LED array light source and a lens; a plant monitor node; a table node, a humidifier node; and a power source configured to operate the system at 12 volts. In one embodiment, the lamp node further comprises a swarm node controller. In one embodiment, the lamp node further comprises a programmable step-up power regulator. In one embodiment, wherein the lamp node further comprises an ultrasound distance module. In one embodiment, the lamp node further comprises a heat sink. In one embodiment, the lamp node further comprises a fan. In one embodiment, the lamp node further comprises a temperature sensor.

In various embodiments, a plant growth system including a lamp node comprising a LED array light source and a lens; a plant monitor node; a table node comprising a rotating platform configured for placement of a plant, a humidifier node; and a power source configured to operate the system at 12 volts. In one embodiment, the plant monitor node further comprises at least one sensor. In one embodiment, the plant monitor node further comprises a sensor selected from the group consisting of: a pH sensor, a moisture sensor, a humidity sensor at the root level, a temperature sensor at the root level, a humidity sensor at the canopy level, a temperature sensor at the canopy level, a carbon dioxide sensor, an oxygen sensor, and a light lumen detector. In one embodiment, the plant monitor node further comprises a power source.

In various embodiments, a plant growth system including a lamp node comprising a LED array light source and a lens, wherein the LED is configured to produce light in at least one of the blue spectrum, red spectrum, and complete visible spectrum; a plant monitor node; a table node comprising a rotating platform configured for placement of a plant, a humidifier node; and a power source configured to operate the system at 12 volts. In one embodiment, the table node further comprises a motion platform. In one embodiment, the table node further comprises a swarm node controller. In one embodiment, the table node further comprises an auxiliary power source. In one embodiment, the table node further comprises a programmable step-up power regulator. In one embodiment, the humidifier node further comprises a humidifier and a humidity sensor. In one embodiment, the humidifier node further comprises a swarm node controller. In one embodiment, the humidifier node further comprises a programmable step-up power regulator. In one embodiment, the humidifier node further comprises an auto-fill hardware.

### BRIEF DESCRIPTION OF THE DRAWINGS

The drawings described herein are for illustration purposes only and are not intended to limit the scope of the present disclosure in any way. Embodiments of the invention will become more fully understood from the detailed description and the accompanying drawings wherein:

FIG. 1 is a top view of a schematic illustration of a plant growth system according to various embodiments of the invention.

FIG. 2 is a side view of the schematic illustration of a plant growth system according to FIG. 1.

FIG. 3 is a schematic representation of nodes of a plant growth system according to various embodiments of the invention.

FIG. 4 is a schematic representation of nodes of a plant growth system according to various embodiments of the invention.

FIG. 5 is a schematic representation of nodes of a plant growth system according to various embodiments of the invention.

FIG. 6 is a schematic representation of a plant growth system according to various embodiments of the invention.

FIG. 7 is a schematic representation of a Lamp Node of a plant growth system according to various embodiments of the invention.

FIG. 8 is a schematic representation of a Plant Monitor Node of a plant growth system according to various embodiments of the invention.

FIG. 9 is a schematic representation of a Table Node of a plant growth system according to various embodiments of the invention.

FIG. 10 is a schematic representation of a Humidifier node of a plant growth system according to various embodiments of the invention.

### DETAILED DESCRIPTION

The following description sets forth examples of embodiments, and is not intended to limit the invention or its teachings, applications, or uses thereof. It should be understood that throughout the drawings, corresponding reference numerals indicate like or corresponding parts and features. The description of specific examples indicated in various embodiments of the invention are intended for purposes of illustration only and are not intended to limit the scope of the invention disclosed herein. Moreover, recitation of multiple embodiments having stated features is not intended to exclude other embodiments having additional features or other embodiments incorporating different combinations of the stated features. Further, features in one embodiment (such as in one figure) may be combined with descriptions (and figures) of other embodiments.

According to several embodiments of the invention, a community based environmental plant growth system 100 for optimizing plant growth is described herein. In various embodiments, a plant growth system 100 is a Controlled Burst Photosynthesis technology, or Photo-burst technology. Whether it be tomatoes, fruit, basil, or parsley, plants all follow the same photosynthesis (e.g., science of molecular photosynthesis) process to live and grow. There are two distinct processes in the photosynthesis cycle. Photosynthesis stage and the Calvin stage.

Photosynthesis Stage (Stage One) uses photonic energy (light) within the Chloroplast cell to produce a positively charged electron from the chlorophyll within the thylakoid. This electron is then transferred to the electron transport chain via an electron uptake. Once in the transfer chain, it is then converted to the molecular precursors of glucose (ATP & NADPH). This process uses photonic light and happens very quickly within nanoseconds of the photon entering the cell membrane. Once the energy is converted to a precursor molecule it is then stored in the stroma fluid in the cell for the next stage.

The Calvin Stage (Stage Two) does not require any photonic energy (no light required) to take the ATP & NADPH stored in the stroma fluid from stage one and form a ATMD molecule which the plant then uses as the energy supply to grow. The molecular process during the Calvin Stage takes place in the Granum and is quite complicated. Due to this complexity, the Calvin stage is timed by minutes to hours to convert all of the precursor molecules into food depending upon how much ATP & NADPH is in the stroma fluid and the bioenvironmental is within optimal parameters.

There is a need to successfully grow plants in challenging photosynthesis environments. Conventional systems for plant growth can be expensive. Electric bills can be considerable to run conventional sodium pressure lights, which generate excessive heat requiring systems to pump excess heat away from the plants. Embodiments of the present invention address the massive loss of untapped energy and high cost associated with current, conventional plant growth systems by improving upon time-tested growing techniques with smart technologies and automation in a way that is accessible to a wide audience for a wide variety of applications.

In various embodiments, the plant growth system 100, the stroma fluid is charged up by Stage One much like a battery and used to power Stage Two. It is this battery-like property of the stroma that the plant growth system 100 process leverages. Much like a battery, the plant growth system 100 can contain a full supply of energy (glouton or glucose precursor) or no precursors (no energy) or any state in between. As opposed to the first light dependent stage that has reaction times counted in nanoseconds, Stage Two (or the Calvin Cycle) can take up to several minutes to convert the stored energy within the stroma.

In some embodiments, the plant growth system 100 process is applied to horizontal growing by being an unfocused LED light source very close to the plant or passing a focus beam over a horizontal garden. However, in both horizontal configurations, the environmental critical zone is very big—the entire length of the canopy or a moving target-moving along the canopy as the light bar is moved. In some embodiments, to improve or maximize efficiency the plant growth system 100 rotates the plant. By turning the plant to expose each leaf to the light, the plant growth system 100 dramatically shrinks the critical reaction zone while making the contact point a fixed location. Using the rotation method maximizes the control and ease of maintaining contact zone while allowing momentary extreme proximity exposure between the lamp and leaf.

By controlling the position, intensity and frequency of the light source along with the precise rotating of the plant while measuring LUDs, pH, Moisture, Humidity Temperature and CO2 concentrate, the plant growth system 100 can achieve the maximum absorption rate. This zone is kept at optimal conditions during the critical step of light absorption, insuring optimal energy absorption while protecting the cell from damage and drastically reducing climate control issues and associated cost.

By passing the leafs of the plant under an intensity focused beam of light, the plant growth system 100 over excites the photosynthesis Stage One process, flooding the stroma with ATP & NADPH thus charging the battery to within maximum capacity. This charge is managed by controlling the focus, intensity, duration and wavelength of the photonic light as well as the environmental characteristics—humidity, temperature, CO2 concentration and air exchange—for this biological effect to take place.

While the leaf is out of direct contact with the light, the Calvin cycle continues to use the stored energy in the stroma to produce glucose thus depleting the stroma's storage by the time the plant revolves back to the light source. Using only brief exposure during the complete cycle allows the leaf to cool down from the intense burst of light and maintain a reaction friendly zone. Because the stroma can be used as a reservoir for the glucose precursor, it can calculate the exact conditions and duration to maximize energy while maintaining an eco-friendly environment.

By placing the plant growth system 100 plant monitor in the turning pot and utilizing the adjustable arm to position LEDs, one or more sensors 290 (e.g., Humidity and Temperature sensors 290) next to a leaf on the edge of the canopy. This feedback sensor allows the plant growth system 100 to take environmental readings This method can also be used in flash photosynthesis by using a traditional overhead light source that is extremely close to the plants and it's only flashed on long enough to charge the stroma. Both methods utilize far more potential photonic energy then the current standard growing method while consuming a fraction of the energy.

In various embodiments, the plant growth system 100 is a modular system of components and software solutions that work together to achieve the healthiest plants possible with the highest yields at the lowest cost possible while expending a low amount of energy. In one embodiment, low-energy lights are used for growing dramatically lower the cost of energy and allows plant growth systems 100 to run off of a 12 volt car battery in many situations. In one embodiment, an adjustable beam of high intensity light emitted by the light promotes uniform plant growth by targeting precise areas of the plant based on real-time analysis and feedback performed by the plant monitoring system, the lights are capable of one, two, or three-axis movement, thereby minimizing lost energy and ensuring that the leaves below the plant canopy stay healthy (unlike previous indoor grow systems). In one embodiment, the lights emit very low heat, eliminating the cost, energy consumption and space necessary for complex ventilation systems. In one embodiment, a unique turn-table system can be used to create fuller plant canopies with even growth in many situations. In various embodiments, the plant growth system 100 can scale from one plant to thousands of plants.

In various embodiments, the plant growth system 100 can comprise or connect with a database of time-tested growing processes that is continuously updated with new information gathered from communication connected plant growth system 100 monitoring systems. People using the plant growth system 100 can participate in a community focused on fostering better understanding of growing optimization for a wide variety of plants and growing environments or an individual can focus solely on learning from his or her own detailed analytics. In various embodiments, features and components of the scalable plant growth system 100 are designed to be user friendly and intuitive for growers of all experience levels and all levels of technical understanding.

In various embodiments, the plant growth system 100 solves some fundamental shortcomings common in current conventional plant growth techniques and systems. In various embodiments, the plant growth system 100 leverages decades of system development, design, data acquisition and technology together to launch a turn-key environmental control system while still maintaining full end-user control to override any or all functions for a fully manual control or any level between. In various embodiments, the plant growth system 100 contains several unique approaches to the standard, conventional methods used during indoor or low-light plant growth, including innovative extensions of the functionality of conventional technologies, and some completely revolutionary concepts in the field that could be brought to fruition with designs for mass produced, miniaturized microprocessors and sensors at a nominal cost.

In various embodiments, a plant growth system 100 is a community driven, modular at-home grow system that supplies and learns the best environment for plant growth using community-based data collection. In one embodiment, each node relays data to its local group (and optionally the cloud based community for users enrolled in data sharing). In various embodiments, data is encrypted and sent to the collective database anonymously. In one embodiment, this information is stored and analyzed to benefit future plants of all enrolled users. Additionally, in some embodiments, a community member can add information about the life cycle of their plant through brief inquiries delivered via a mobile application or website. In one embodiment, the plant growth system 100 is configured to contact the user if it determines the plant needs intervention and through alerts and inquires will suggest the next course of action. In one embodiment, the plant growth system 100 is configured to contact the user for any environmental controls, daily plant diagnosis and hardware issues as well as plant growth milestones. For enrolled members, the successes and pitfalls during the life-cycle is aggregated into the community for all members to benefit from. In one embodiment, the plant growth system 100 nodes can work independently or in groups. In one embodiment, the plant growth system 100 is configured the user app/website allows both control over the plant growth system 100 and access to the knowledge base of the cloud-based community. In various embodiments, optimal growth settings, illness corrections, troubleshooting, user tips, etc. can be directly accessed by all users and automatically downloaded into that their system for a self-correcting capable environment. In one embodiment, user participation in the data collection is strictly opt-in and non-validated users are welcome to the community's data.

In one embodiment, the plant growth system 100 uses a unique LED and Turntable technology which allows a computer control to supply all the plant's light wave energy needs by turning the plant via a computer controlled table. In one embodiment, the plant growth system 100 light and table modules automatically sense each other and follow a preprogrammed timetable covering the life cycle of the plant. Precise control of both the light source and the plants rotation optimize the photosynthesis process at a molecular level to deliver all the energy required to grow. This process is extremal efficient and reduces the cost of growing the plant throughout its life-cycle dramatically. By developing a database of time-tested growing processes that integrates with a complex (but easy to use) real-time plant monitoring and management system and proprietary lighting techniques, growers with all levels of experience can optimize the health of their plants, get better yields, automate many parts of the growing process, save energy, money and time and possibly grow more in a smaller space.

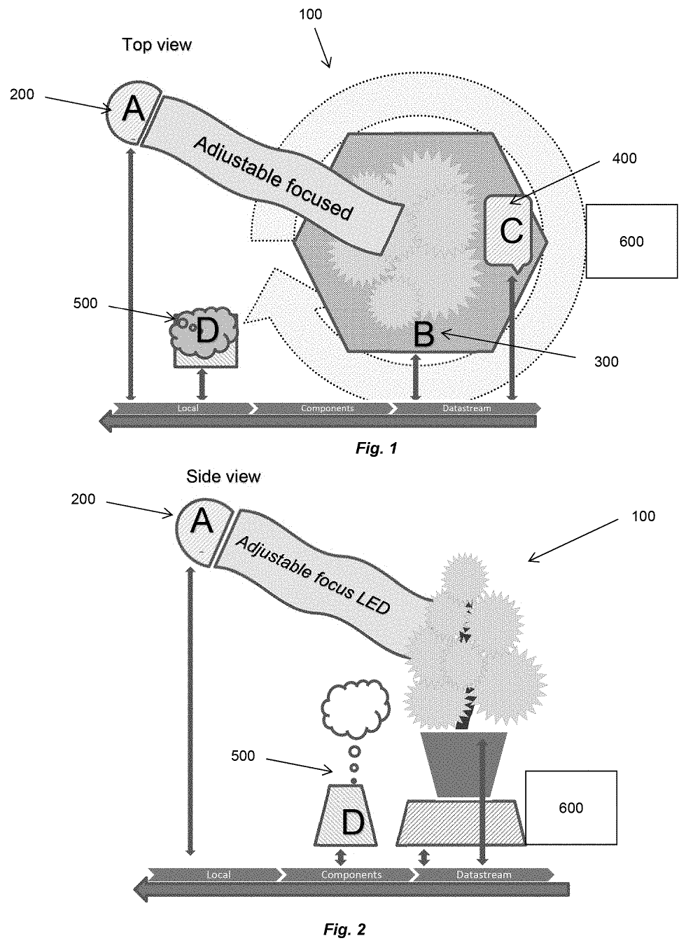

According to embodiments in FIGS. 1 and 2, a plant growth system 100 comprises, essentially consists of, or consists of the following components:

A) a Lamp Node 200

B) a Plant Monitor Node 300

C) a Table Node 400

D) a Humidifier node 500

E) a Power Source 600

In various embodiments, the components of the plant growth system 100 are modular, and configured to be customized, optionally utilizing or leaving slots empty for programmable optional uses. There are open channels for the consumer to customize their system.

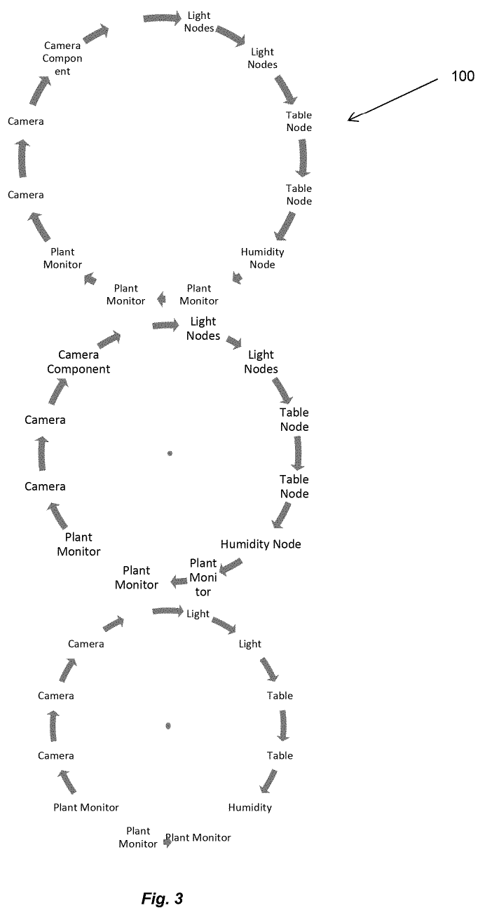

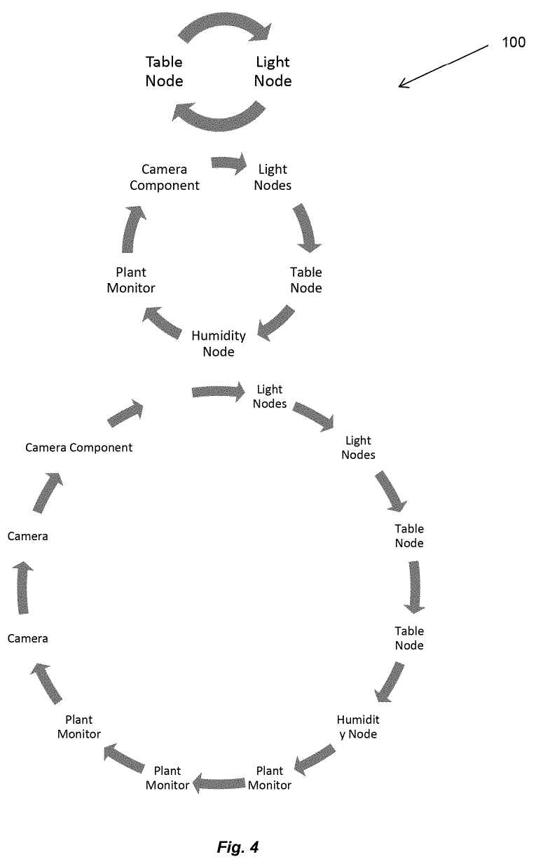

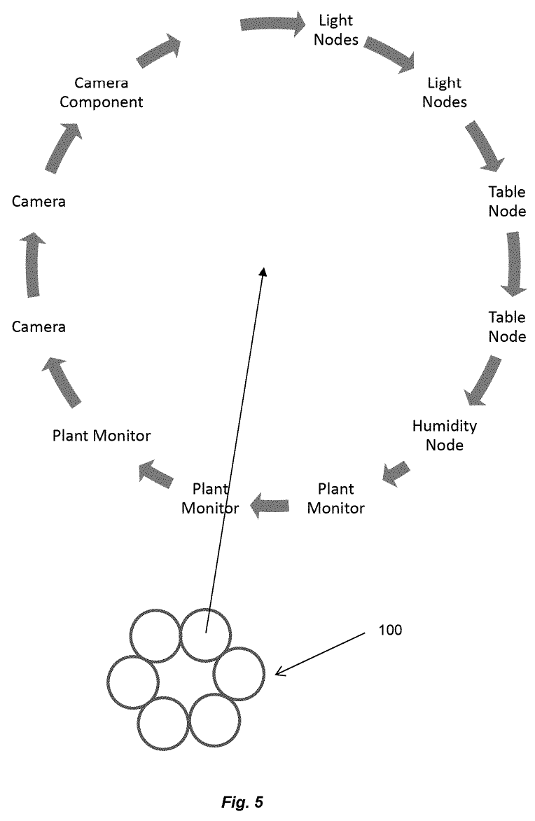

FIGS. 3, 4, and 5 illustrate various examples of scalable, module nodes working in conjunction for various embodiments of a plant growth system 100.

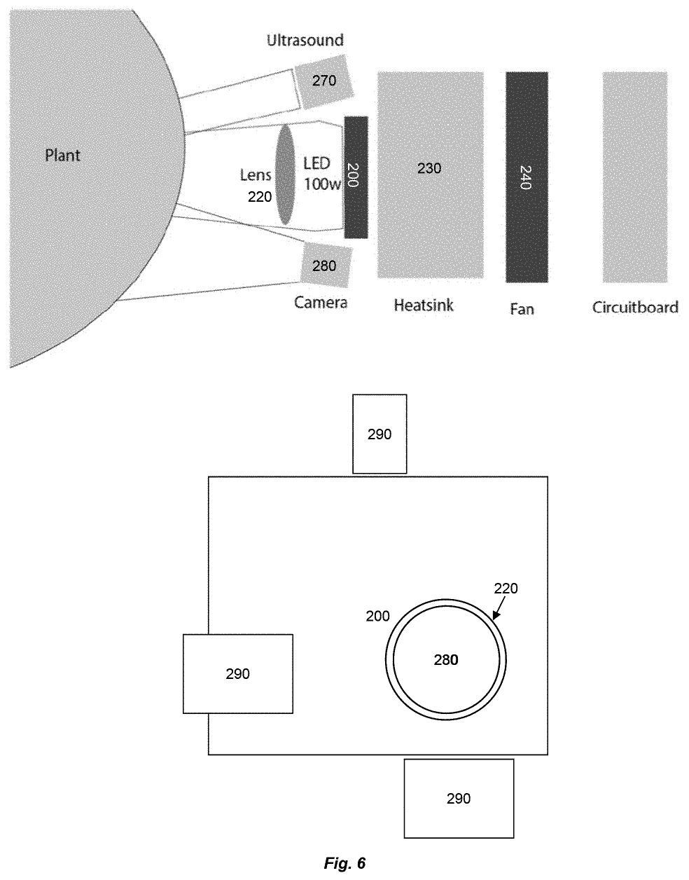

FIG. 6 illustrates one embodiment of the plant growth system 100, electronics that support the ultrasound sensor, pattern recognition high resolution camera, communications and controller are mounted on the heatsink along with a wavelength specific LED light module and adjustable optical lensing. This self-contained compact design allows the lamp to be mounted in both the traditional hanging style as well as attached to an adjustable arm. Using an adjustable arm allows the plant growth system 100 to aim the light at any angle in any position allowing the plant growth system 100 to optimize the exposure the plant receives both on the outer canopy at the leaves below. The adjustable lens on the front of the light allows for a tight beam to a wide flood to control the focus of photonic energy. This concentrated beam with light and the ability to adjust its focus and aim to any angle overcomes the restricted penetration of the LED wavelength compared to conventional lights. This allows wavelength specific light to penetrate deep past the canopy to the leaves below. An ultrasonic depth sensor can calculate the amount of light required for the distance of the plant incumbency for weather the light is fixed or moving across the leaves. The entire light assembly utilizes a 12 volt power supply with step up technology allowing for quick long lasting battery backup. In one embodiment, adding a pattern recognition camera attached to the front and the addition of a 2-axis gimbal provides for the ability to change the angle of the light and sample image the entire plant for diagnostics and logging purposes. This high resolution camera recognizes common ailments detective in the plant's leaves color and growth and is capable of auto diagnostic of the plants health during the stages of growth. A humidity and temperature sensor can also be attached to monitor the environment via the light controller. In an embodiment, the light has built in Wi-Fi and low-frequency swarm technology allowing all of the plant growth system 100 components to communicate and auto configure themselves or be governed by the user or collective intelligence via the plant growth system 100 online community. The on-board controller takes care of the Wi-Fi connections and functions up the light including intensities an on-off cycles. The light can run independently or part of a cluster. In addition the light is capable of rotating on two axis in order to coordinate with the rotation table to create even sweeps across the foliage. In one embodiment, a Lamp Node 200 comprises a 100 W LED array that is wavelength specific with a glass optical lens focus light beam (30°, 60°, 120°), a depth sensor, a high resolution camera, a pattern recognition system, a 6-axis position sensor (for x-axis, y-axis, z-axis, and rotation around each respective x, y, and z axes), and mounting screws that can be mounted on a fixed mount or flexible arm.

### Lamp Node:

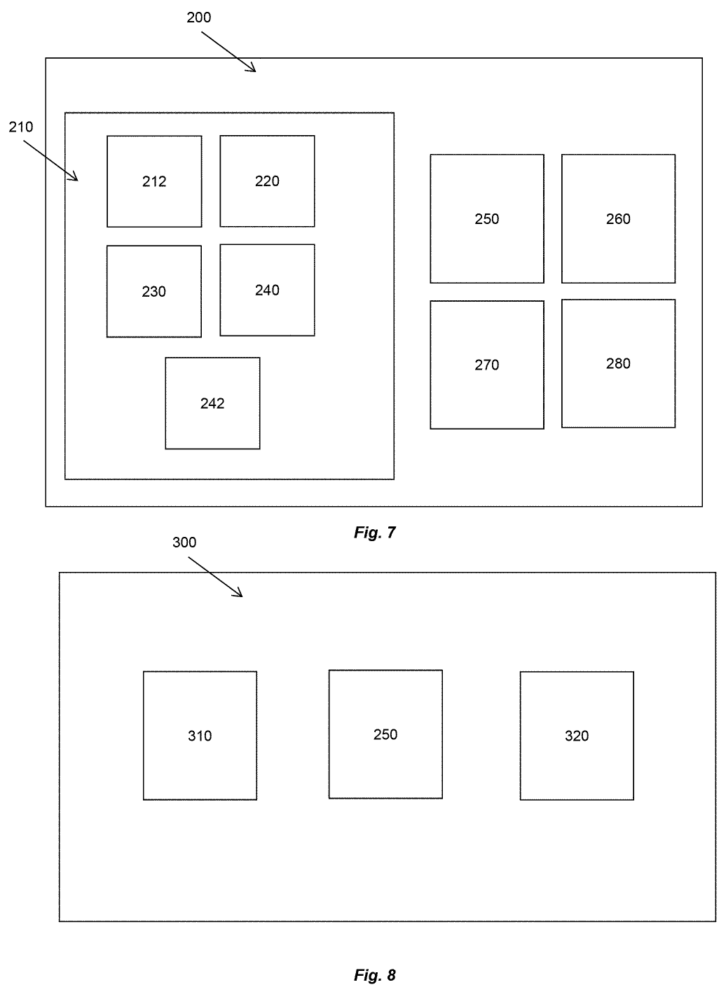

As illustrated in FIG. 7, in various embodiments, a Lamp Node 200 comprises Lamp Node components 210, a Swarm Node Controller 250, a Programmable Step-up Power Regulator 260, and an Ultrasound Distance Module 270, and/or a Camera Module 280.

In various embodiments, Lamp Node components 210 comprise one or more of a light source 212, a lens 220, a heat-sink 230, a fan 240, a temperature sensor 242, which is configured to monitor and adjust cooling needs of the LED module.

In one embodiment, the light source 212 is an LED module. One issue with conventional systems employing LEDs is that the LED light produced does not travel as far or penetrate the plant's dense canopy as well as the incandescent bulb. A conventional light hits the plant, making it to a first leaf on the outer shell of the plant canopy but it can't penetrate inside of the plant beyond the outer shell. When conventional systems employ stronger, intense LEDs the plants can be extremely sensitive to too much light. In one embodiment, a high intensity 100 watt LED light is connected to a “step up” transformer, e.g., a Programmable Step-up Power Regulator 260, to provide the proper voltage for each of the LEDs. In one embodiment, the light source 212 comprises an array of LEDs. In various embodiments, the LED panels are in arrays. In one embodiment, a LED array is an array of smaller LEDs (about 3 volts) that when put together, creates about 400-1000 watts of light.

In various embodiments, a light source 212 produces a focused adjustable beam of high intensity light specifically calibrated to produce the spectrum specific wave length of light needed for growth or blooming to a small, focused area of the plant. In one embodiment, the light source 212 is configured for three axis movement and adjustable intensity to targets precise areas of the plant to help promote uniform growth.

In various embodiments, a light source 212 comprises one or more particular light spectrum(s). In one embodiment, blue light makes the plant stretch to the light source. In one embodiment, a blue LED is used in the plant's photosynthesis process as what's called the “stretch”—when the plant is exposed to this particular frequency of blue light, a reaction inside the plant makes the leaves stretch towards the light source. Use of blue light is abundant in the growing phase. In one embodiment, a broad overall spectrum light spreads that light across the plant. As the plant matures, other spectrum colors come into play, including a wide spectrum (like the sun itself) and also supplying the plant with trace element light frequencies that it uses for specific purposes. The light energy is transferred to the plant's leaves, then with the plant combined with CO₂ turns that into energy to grow then the production of oxygen through photosynthesis. In one embodiment, a red light spectrum promotes the budding process within the plant itself. This helps the plant flower or produce buds. In one embodiment, red light makes the plant bloom or generate stem leaves.

In one embodiment, the light source 212 is moveable, with one or more pivots and/or motion in one, two, or three dimensions. Each degree of freedom may be locked or moved manually or automatically.

In various embodiments, a lens 220 focuses the light on the plant. In one embodiment, the lens 220 can focus from 0 to 180 degrees, and any values in between. In various embodiments, the lens 220 narrows the light beam and focuses the energy into the plant's leaves. If the light source was left on a particular leaf for more than a minute, it could burn the leaf. But the computer controlled Table Node 400 turntable can be operated at any speed, forward, backward, clockwise, and/or counter clockwise in order to control how much light is being delivered to each leaf every minute of the day. For example, there is a distinct difference between two plants examples: a plant growing with rotation in the plant growth system 100 has a very tall, narrow growth pattern and a plant that is not rotating has spread out and has more dead leaves and is not as robust as a plant with the plant growth system 100. In one embodiment, the light covers the entire height of the plant when rotating, resulting in lush growth even at the bottom of the plant.

In various embodiments, a heat-sink 230 helps draw excess heat away from the plant or Lamp Node components 210 or Lamp Node 200.

In various embodiments, a fan 240 is placed near the plant. In one embodiment, a fan 240 is placed towards the bottom of the stand are clipped towards the bottom of the light stand/array. Plants don't have a respiratory system, so the air (carbon dioxide CO₂ as well as oxygen O₂) can be moved between the leaves and as a result, the fan creates wind flow to distribute the air. In one embodiment, the CO₂ sensor is at the bottom of the plant base.

In various embodiments, each one of the units/processors is attached to each component, whether it be the temperature module, light module, table module, etc., and the plant growth system 100 is configured bring operate with other accessories and modules in addition to the original module. Other components include precision light sensor, humidity sensor, temperature sensor, CO₂ sensor, O₂ sensor, moisture sensor, light lumen detector, pH sensor.

In various embodiments, the Swarm Node Controller 250 controls the intensity of the lights and controls the position of the plant. The Swarm Node Controller 250 determines the distance between the light and plant and adjusts light and positioning to improve the success of the growth cycle. In one embodiment, the Swarm Node Controller 250 controls timing, intensity and cooling functions. In one embodiment, the Swarm Node Controller 250 calculates and reports distance from target object. In one embodiment, the Swarm Node Controller 250 compares target distance and controls a user interface on-board meter for easy placement. In one embodiment, the Swarm Node Controller 250 dims intensity of LED if plant comes too close to the node. In one embodiment, the Swarm Node Controller 250 calculates if device complies with turntable data and engages warning and safety shutdown should a malfunction take place. In one embodiment, the Swarm Node Controller 250 manages add-on sensors and/or devices. In one embodiment, the Swarm Node Controller 250 manages all communications.

In one embodiment, the Swarm Node Controller 250 comprises a Node-Common Controller. In one embodiment, the Node-Common Controller comprises a microcontroller, processor, 2.4 MHz Wi-Fi Microcontroller/Processor, a 433 Hz Local node transmitter, receiver, a power regulator, and/or a backup. In one embodiment, the microcontroller or processor handles all operational functions of the given Node. In one embodiment, the microcontroller or processor handles all add-on sensors and auxiliary inputs and outputs (IOs). In one embodiment, the microcontroller or processor manages local node communication.

In one embodiment, the 2.4 MHz Wi-Fi Microcontroller/Processor comprises a Web Portal UI for user interaction (Wi-Fi & node settings). In one embodiment, the 2.4 MHz Wi-Fi Microcontroller/Processor controls data share for local nodes. In one embodiment, the 2.4 MHz Wi-Fi Microcontroller/Processor establishes and maintains both cloud and local node's communications. In one embodiment, the 2.4 MHz Wi-Fi Microcontroller/Processor comprises a communication routing. In one embodiment, the 2.4 MHz Wi-Fi Microcontroller/Processor manages Wi-Fi connect to local hotspot. In one embodiment, the 2.4 MHz Wi-Fi Microcontroller/Processor relays information to cloud for analyzing and data collection. In one embodiment, the 2.4 MHz Wi-Fi Microcontroller/Processor comprises Listen/Capture/Respond functions for node-specific communication from both local (433 Hz) and cloud-based (2.4 MHz) data streams.

In various embodiments, the Programmable Step-up Power Regulator 260 provides the LED with the correct amount of electricity to produce a specific intensity going to the plant. In one embodiment, a Programmable Step-up Power Regulator 260 comprises modified standard step-up regulators to add digital-to-analog voltage and/or current levels adjustments. In one embodiment, a Programmable Step-up Power Regulator 260 supplies the light source with exact voltage to control lamp intensity and/or active state.

In various embodiments, an Ultrasound Distance Module 270 supplies a constant or intermittent stream of measurements for the distance of the node to target allowing intensity adjustments to LED modules. In various embodiments, an Ultrasound Distance Module 270 creates a 3D area map of plant to calculate volume and growth over time.

In one embodiment, a Camera Module 280 creates a 3D area map of plant to calculate volume and growth over time. In one embodiment, a Camera Module 280 comprises a High Definition Camera and an image encoder (e.g., JPG, JPEG), and is electrically connected to the Swarm Node Controller 250. In one embodiment, the Swarm Node Controller 250 collects and verifies growth data via a time period snapshot (e.g., hourly, daily, weekly, monthly).

In one embodiment, the Swarm Node Controller 250 verifies, analyses, and stores data for the community. In one embodiment, the Swarm Node Controller 250 users have full access to their photo library and can delete or share any image(s). In one embodiment, the Swarm Node Controller 250 photos in the library will be flagged unprocessed if not completed with analysis (users may delete unprocessed photo as well). In one embodiment, the Swarm Node Controller 250 is used for diagnosis of illness and leaf drop rate. In one embodiment, during examination cycles the High Definition Camera syncs with the LED nodes supplying the correct color spectrum to reveal leaf yellowing (e.g., a sign of illness during live-cycle and drop-rate during final grow phase). In one embodiment, the image encoder is a JPG Encoder. Depth sensors and a FPV camera allow the plant growth system 100 OS (Operating System) to map each plant in a 3D work space. Camera imagery can be applied to this map for viewing and to detect plant health issues such as nutrient issues, under feeding, over feeding, insect invasion, etc. The data collected is analyzed and the system adjusts to promote recovery. Recommendations are also provided for issues that cannot be overcome by automated adjustments.

### Plant Monitor Node:

As illustrated in FIG. 8, in various embodiments, a Plant Monitor 300 comprises one or more sensors 310, and is connected to the Swarm Node Controller 250 and a power source 320.

In one embodiment, a Swarm Node Controller 250 comprises one or more replaceable sensors such as one, two, three, or more of the group consisting of: a pH sensor, a moisture sensor, a humidity sensor at the root level, a temperature sensor at the root level, a humidity sensor at the canopy level, a temperature sensor at the canopy level, a carbon dioxide sensor, an oxygen sensor, and a light lumen detector (e.g., LUD Meter). In various embodiments, a plant growth system 100 is broken into multiple components, from meters that read pH, humidity, temperature at the root level, temperature at the canopy level, to CO₂ sensors, to humidity control sensors, and other sensors.

In one embodiment, a light lumen detector measures how much light a plant is getting. Generally, plants need at least 300 light lumens (e.g., LUG) to grow, several plants grow optimally between 400-600 light lumens (e.g., LUG). In some embodiments, an ultrasound sensor measures distance between the plant and light source. In some embodiments, a sensor detects burn and the data is then pushed to the application, which learns from the community experiences and gather, analyze, and provide feedback on optimal distances between lights and particular plants in their stage in the growth cycle. In various embodiments, the Swarm Node Controller 250 can wake the plant up with blue spectrum light, then switch to full spectrum and/or red spectrum and alter the intensity of the lamps as well to get the optimal amount of light and type of light.

In one embodiment, a Swarm Node Controller 250 collects sensor 310 information and reports back to a data stream.

In one embodiment, the power source 320 is a battery. In one embodiment, the battery is a Lithium battery. In one embodiment, the battery is a backup power source.

### Table Node:

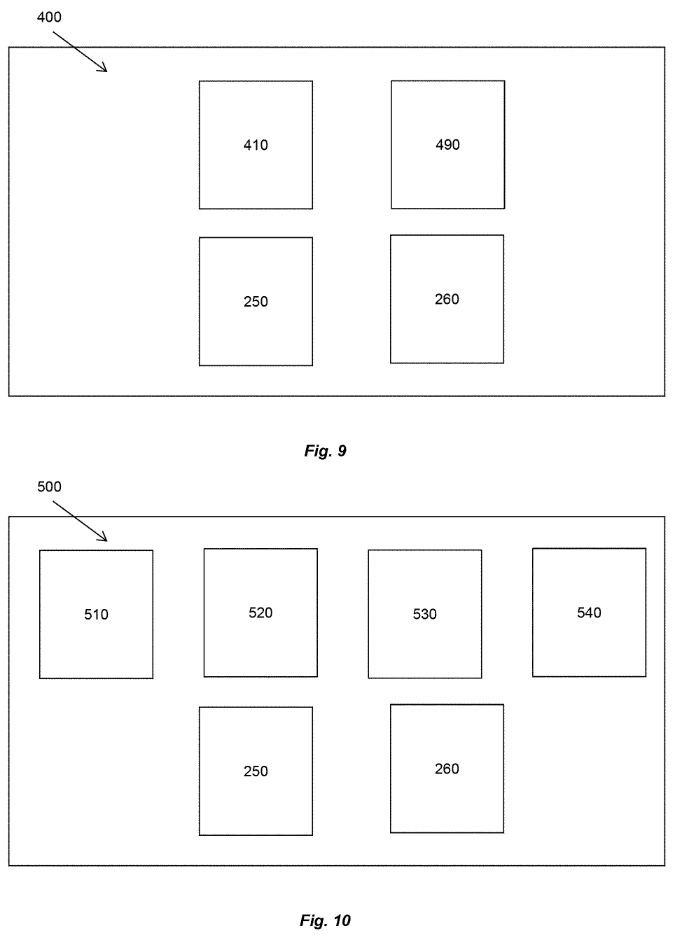

As illustrated in FIG. 9, in various embodiments, a Table Node 400 comprises a Motion Platform 410, Swarm Node Controller 250, a Programmable Step-up Power Regulator 260, and an optional Auxiliary power 490 for the Motion Platform 410.

In one embodiment, a Motion Platform is a rotating table. The turning table with controller allows the table to go backward and forward at any particular speed and includes a WiFi module with feedback capability. The jack plugs in the sensor unit and is WiFi enabled as well to monitor humidity and temperature variables at the root base and canopy top (since it usually gets hotter there). The temperature monitoring between 2 levels helps estimate the overall temperature in the room, which then you can adjust as needed.

In one embodiment, a Swarm Node Controller 250 controls timing, speed and direction of the table motion. In one embodiment, a Swarm Node Controller 250 calculates optimal settings using feedback from local and cloud data. In one embodiment, a Swarm Node Controller calculates and reports table speed. In one embodiment, a Swarm Node Controller 250 engages a warning and safety shutdown should a malfunction take place. In one embodiment, a Table Node 400 comprises a rotating turntable. In one embodiment, a rotating turntable demonstrates improved plant growth and life with fewer dead leaves, less yellowing of the plant, a full canopy, more lush growth. In one embodiment, the plant growth system 100 is configured for sculpting to a desired or pre-configured plant shape, e.g., growth emphasis on a stalk or growth emphasis on spreading out.

In one embodiment, a Programmable Step-up Power Regulator 260 supplies the table motor with a set voltage to control speed and direction.

In one embodiment, Auxiliary power 490 for rotation table is used for plant monitoring, auxiliary sensors, and/or auxiliary devices on or around the Table Node 400.

### Humidifier Node:

As illustrated in FIG. 10, in various embodiments, a Humidifier Node 500 comprises a humidifier 510, Swarm Node Controller 250, and a Programmable Step-up Power Regulator 260, and optional Auto-Fill Hardware 520, a Humidity sensor 530, and a Temperature sensor 540.

In one embodiment, the humidifier runs operates with 12 volts of power. This is unusual, as conventional humidifiers operate with much higher voltage. In one embodiment, a two gallon water tank with a float and a celluloid that fits in the humidifier is configured to siphon from any water source (e.g., faucet, jug, container) desired. In one embodiment, a dosing pump is configured for dosing nutrients to plant when needed. In one embodiment, water is pumped into the system. In one embodiment, a humidifier is a converted ultrasound mechanism with a ventilation system operating at 12 volts.

In one embodiment, a Swarm Node Controller 250 sets humidity target and executes the functions required to maintain the humidity target with one or more of the following: controlling the functions of the humidifier device (on/off, water level, intensity, etc.); managing add-on sensors and/or devices; and managing all communication.

In one embodiment, a Programmable Step-up Power Regulator 260 allows control of the humidifier voltage and output, and enables the control of unit output and timing.

In one embodiment, an Auto-Fill Hardware 520 comprises tubing, a 12 volt flow value, and a fill sensor, which allows the unit to use either the tank or autofill. In one embodiment, water sensors alert the unit when water is low and activates a valve allowing for a water line tap value. In one embodiment, the system alerts the user should water run low or malfunction.

In one embodiment, a Humidity sensor 530 can target a humidity level can be achieved by a variety of choices: (i) Internal sensors, (ii) a reassigned sensor from another node, and/or (iii) an average from any collection of user selectable local readings.

### Power Source

In various embodiments, a plant growth system 100 has a power source 600. In one embodiment, the power source 600 operates at 12 volts. In various embodiments, a plant growth system 100 has a power source that is specifically designed to run off a standard computer supply. In various embodiments, a plant growth system 100 has a power source that operates at 12 volts and is specifically designed to run off a standard computer supply. In one embodiment, a 400 watt power supplies control the entire system. During a power failure, the system automatically switches over to a battery (e.g., a marine battery, a car battery, etc.). If you expect a power failure to be long lasting you can hook up a couple of jumper cables and hook up to your car. The electrical cost to run the entire system is quite affordable.

In various embodiments, a plant growth system 100 is operated with a low voltage power source. In one embodiment, a 12 volt power system is employed. In various embodiments, an entire plant growth systems comprising one or more of lights, humidity control, heating, cooling, plant motion and light motion are all powered at 12 volts. In one embodiment, a 12 volt system is run from external power, remote solar power, AC power, DC power, and/or a battery. In various embodiments, back-up power is provided, such as with a 12 volt battery/batteries. In one embodiment, the entire system can run off a car battery during a power failure for a long period of time. Components for a 12 volt powered plant growth system can be inexpensive. In various embodiments, interchangeable parts can be purchased at a relatively low cost. In various embodiments, a low frequency transmitter boosts WiFi signals from a growth room/area and can be connected to one or more, or even all the components. In various embodiments, solar panel transmitters and plugins are provided.

In one embodiment, the plant growth system 100 is based on a 12-volt power supply and can operate full a standard computer power supply unit. During power outages, all functions are automatically switched to battery backup and the user is alerted to the issue.

In one embodiment, a plant growth system 100 comprises, essentially consists of, or consists of the following components:

a lighting module/stand 200;

a fan for wind flow (on or off the stand);

a humidifier 500 (augmented for larger capacity and more robust wet environment);

a plant base 400 (rotatable, moveable);

a sensor (CO2, light, humidity/temperature, wind/air flow, plant growth, etc.)

a power source (12 volt battery, AC, DC, etc.) with micro transmitters, solar panel plug-in's as an option;

a Wi-Fi extender;

an application, such as App data being gathered and UI/UX, tutorials on how to grow that is aggregated with the data of all users; and/or

an optional ability to customize the grow system with available/empty slots.

In various embodiments, an online community employs a cloud computing environment is designed to help bridge generational and knowledge gaps and create a reliable community where all users can contribute to the community. The plant growth system 100 cloud and management hardware fills in the communications and knowledge gap by use of its custom data, hardware, and feedback and user input analytics engines. The CMS (content management system) is directly linked to the GMS (growth management system) resulting in a fully customizable user interface which helps fill in the unknowns for all groups. In one embodiment, the hardware is completely integrated both by standard Wifi/Internet connectivity and a private low frequency wide coverage transceiver to allow component interaction over wide areas and ensures the data collection is accurate and reproduceable. This allows the system to be completely turn-key, assist only or any level in between throughout each grow cycle. In various embodiments, a Wifi unit connects to the community database anonymously to get commands to control the lights and other features of the modular plant growth system to create optimal growth conditions in each unique grow environment. In one embodiment, data is sent via encrypted code. In one embodiment, the community database is continually updated based on data from all growers connected to the community. In one embodiment, data collected by the Grow Monitoring System is compared to the community database and if disease or any other issue arises a new set of commands to resolve the issue is sent via Wifi to be processed and executed by the processor.

In one embodiment, the plant growth system 100 central control unit is common to all system hardware components and allowing for a plug and play style architecture for the end user. This allows plant growth system 100 products to work as standalone or as a collective.

The plant growth system 100 operating system (OS) is custom coded to recognize other components capabilities and share data and sensor readings. The OS creates the infrastructure for data collection and processing, logging and data sharing within an assignable group allowing independent groves to co-exist within close proximity such as found in large grow warehouses. In one embodiment, dual microprocessors on the board assign all in-bounce and outgoing communication streams to a dedicated processor while the secondary processor controls and monitors the component's specific hardware functions.

In one embodiment, unused data ports on a component are assigned for add-ons, such as temperature readers, humidity readers, CO₂ readers, watering control, airflow control, a 2.4 gh Wifi transceiver allows the user to connect directly to the component for setup and control functions via a mobile device. The user can also connect the component to the internet through any available Wifi router for offsite access or cloud registration. The components communicate with each other via a secondary ultra low frequency transceiver.

In various embodiments, these configuration offers multiple benefits such as the ability to say in constant contact with each other without using any Wifi bandwidth ensures that internet communications are quickly responded to; ultra low frequency transmissions have a much higher range allowing for more units in larger areas; transceivers create a node web that relay a communal stream of data to all components; and/or emergency communications for components with failed Wifi connection to alert the user of a system failures. In case of a failed ultra-low transceiver, the OS knows to use the Wifi to alert the user.

Further, areas of applicability will become apparent from the description provided herein. It should be understood that the description and specific examples are intended for purposes of illustration only and are not intended to limit the scope of the embodiments disclosed herein. In some embodiments, the system comprises various features that are present as single features (as opposed to multiple features). Multiple features or components are provided in alternate embodiments. In various embodiments, the system comprises, consists essentially of, or consists of one, two, three, or more embodiments of any features or components disclosed herein. In some embodiments, a feature or component is not included and can be negatively disclaimed from a specific claim, such that the system is without such feature or component.

Some embodiments and the examples described herein are examples and not intended to be limiting in describing the full scope of compositions and methods of these invention. Equivalent changes, modifications and variations of some embodiments, materials, compositions and methods can be made within the scope of an embodiment of the invention, with substantially similar results. The methods summarized above and set forth in further detail herein describe certain actions taken by a practitioner; however, it should be understood that they can also include the instruction of those actions by another party.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents, and alternatives falling within the spirit and scope of the various embodiments described and the appended claims. Any methods disclosed herein need not be performed in the order recited. The methods disclosed herein include certain actions taken by a practitioner; however, they can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers proceeded by a term such as “about” or “approximately” include the recited numbers. For example, “about 433 MHz” includes “433 MHz.” Where an indefinite or definite article is used when referring to a singular noun, e.g., “a,” “an,” “the,” this includes a plural of that noun unless something else is specifically stated.

What is claimed is:

1. A plant growth system comprising:
a lamp node comprising a LED array light source and a lens;
a plant monitor node;
a table node,
a humidifier node; and
a power source configured to operate the system at 12 volts.

2. The plant growth system of claim 1, wherein the lamp node further comprises a swarm node controller.

3. The plant growth system of claim 1, wherein the lamp node further comprises a programmable step-up power regulator.

4. The plant growth system of claim 1, wherein the lamp node further comprises an ultrasound distance module.

5. The plant growth system of claim 1, wherein the lamp node further comprises a heat sink.

6. The plant growth system of claim 1, wherein the lamp node further comprises a fan.

7. The plant growth system of claim 1, wherein the lamp node further comprises a temperature sensor.

8. A plant growth system comprising:
a lamp node comprising a LED array light source and a lens;
a plant monitor node;
a table node comprising a rotating platform configured for placement of a plant,
a humidifier node; and
a power source configured to operate the system at 12 volts.

9. The plant growth system of claim 6, wherein the plant monitor node further comprises at least one sensor.

10. The plant growth system of claim 6, wherein the plant monitor node further comprises a sensor selected from the group consisting of: a pH sensor, a moisture sensor, a humidity sensor at the root level, a temperature sensor at the root level, a humidity sensor at the canopy level, a temperature sensor at the canopy level, a carbon dioxide sensor, an oxygen sensor, and a light lumen detector.

11. The plant growth system of claim 6, wherein the plant monitor node further comprises a power source.

12. A plant growth system comprising:
a lamp node comprising a LED array light source and a lens,
wherein the LED is configured to produce light in at least one of the blue spectrum, red spectrum, and complete visible spectrum;
a plant monitor node;
a table node comprising a rotating platform configured for placement of a plant,
a humidifier node; and
a power source configured to operate the system at 12 volts.

13. The plant growth system of claim 12, wherein the table node further comprises a motion platform.

14. The plant growth system of claim 12, wherein the table node further comprises a swarm node controller.

15. The plant growth system of claim 12, wherein the table node further comprises an auxiliary power source.

16. The plant growth system of claim 12, wherein the table node further comprises a programmable step-up power regulator.

17. The plant growth system of claim 12, wherein the humidifier node further comprises a humidifier and a humidity sensor.

18. The plant growth system of claim 12, wherein the humidifier node further comprises a swarm node controller.

19. The plant growth system of claim 12, wherein the humidifier node further comprises a programmable step-up power regulator.

20. The plant growth system of claim 12, wherein the humidifier node further comprises an auto-fill hardware.
